(19) United States
(12) Patent Application Publication
(10) Pub. No.: US 2006/0041611 A1
(43) Pub. Date: Feb. 23, 2006

(54) Data transfer control system, electronic apparatus, and program

(76) Inventors: Shinichiro Fujita, Kitakyushu (JP); Hiroyuki Kanai, Shiojiri (JP); Koji Nakao, Matsumoto (JP); Hiroshi Yakushiji, Kitakyushu (JP)

Correspondence Address: HARNESS, DICKEY & PIERCE, P.L.C., P.O. BOX 828, BLOOMFIELD HILLS, MI, 48303, US

(21) Appl. No.: 11/186,080

(22) Filed: Jul. 21, 2005

(30) Foreign Application Priority Data
Aug. 19, 2004 (JP) 2004-239631

(51) Int. Cl. G06F 15/16

(52) U.S. Cl. 709/200

(57) ABSTRACT

A data transfer control system that controls data transfer between a first electronic apparatus connected via a first bus and a device connected via a second bus, including: a management section that conducts a process of receiving a login request when a login request for acquirement of a right to access to the device comes from the first electronic apparatus and that conducts a process of receiving a logout request when a logout request for abandonment of the access right acquired upon receipt of the login request comes from the first electronic apparatus; and a power control section that conducts power control by turning on power supply to the device when the login request to the device comes from the first electronic apparatus.

### BACKGROUND OF THE INVENTION

1. Technical Field

The present invention relates to a system, an electronic apparatus, and a program for data transfer control.

2. Related Art

In recent years, high-speed serial interfaces such as IEEE1394 and USB2.0 are drawing much attention. In order to realize these high-speed serial interfaces, there are various conventional methods for reducing electricity consumption of an electronic apparatus which incorporates therein a data transfer control system.

However, in the conventional methods, the electricity consumption of the electronic apparatus (a peripheral apparatus) incorporating the data transfer control system is realized, for example, by detecting statuses of power supply in a host system such as a personal computer (PC). Further, not enough reduction of electricity consumption has been realized with devices such as a hard disc drive (HDD) contained in the electronic apparatus.

Japanese Unexamined Patent Publication No. 11-212681 is an example of related art.

### SUMMARY

An advantage of the invention is to provide a system, an electronic apparatus, and a program for data transfer control which can realize power control that can highly effectively reduce electricity consumption.

The invention relates to a data transfer control system that controls data transfer between a first electronic apparatus connected via a first bus and a device connected via a second bus, including: a management section that conducts a process of receiving a login request when a login request for acquirement of a right to access to the device comes from the first electronic apparatus and that conducts a process of receiving a logout request when a logout request for abandonment of the access right acquired upon receipt of the login request comes from the first electronic apparatus; and a power control section that conducts power control by turning on power supply to the device when the login request to the device comes from the first electronic apparatus.

In the invention, when the login/logout request for acquirement of/abandonment of the right to access to the device comes, the process of receiving the request is carried out. Then, when the login request comes in (when the login request is received), the power control is carried out by turning on power supply to the device, and the data transfer between the first electronic apparatus and the device is conducted. Consequently, the power supply to the device can stay turned off until the login request comes in, and the power control that can highly effectively reduce electricity consumption can be realized.

Further, in the invention, the power control section may conduct power control by turning off or saving power supply to the device when a logout request to the device comes from the first electronic apparatus.

As a consequence, after the logout request comes, the power supply to the device can be turned off or saved, and unwanted electricity consumption can be avoided at the device that stopped being used upon the logout.

Furthermore, in the invention, the power control section may conduct power control by turning off or saving power supply to the device when the first bus turns non-biased or disconnected.

Additionally, in the invention, a first data transfer process between the first electronic apparatus and the device may be switched to a second data transfer process between the second electronic apparatus and the device when the first bus is not in an active state and when power supply of a power line of a third bus that is connected to a second electronic apparatus is in an on state.

Consequently, the switch from the first data transfer control process to the second data transfer control process is possible by a simple determination process.

In addition, in the invention, the power control section may conduct power control by turning off power supply to a link layer circuit used for the first data transfer process when the first data transfer process is switched to the second data transfer process.

Moreover, in the invention, the second data transfer process may be switched to the first data transfer process when the first bus is in an active state and when power supply of the power line of the third bus is in an off state.

Consequently, the switch from the second data transfer control process to the first data transfer control process is possible by a simple determination process.

Further, in the invention, the power control section may conduct power control by turning on power supply to a link layer circuit used for the first data transfer process when the second data transfer process is switched to the first data transfer process.

Furthermore, the invention relates a data transfer control system that controls data transfer between a first electronic apparatus connected via a first bus and a device connected via a second bus, including: a management section that conducts a process of receiving a login request when a login request for acquirement of a right to access to the device comes from the first electronic apparatus and a process of receiving a logout request when a logout request for abandonment of the access right acquired upon receipt of the login request comes from the first electronic apparatus; and a power control section that conducts power control by turning off or saving power supply to the device when the logout request to the device comes from the first electronic apparatus.

In the invention, when the login/logout request for acquirement/abandonment of the right to access to the device comes in, the process of receiving the request is carried out. Then, when the logout request comes in (when the logout request is received), the power control is conducted by turning off or saving power supply to the device. As a consequence, it is able to avoid unwanted electricity consumption at the device that stopped being used upon the logout.

Further, the invention relates to an electronic apparatus including: the data transfer system of any of the descriptions above; and the device connected via the second bus.

Furthermore, the invention relates to the electronic apparatus, further including: a power switch that turns on or off power of an electronic apparatus; a power supply circuit that supplies power when the power switch is turned on; and a switch circuit, which receives a power control signal for controlling power supply from the data transfer control system to the device, supplies power from the power supply circuit to the device when the power control signal turns active, and turns off or saves power supply from the power supply circuit to the device when the power control signal turns inactive.

Moreover, the invention relates to a program that controls data transfer between a first electronic apparatus connected via a first bus and a device connected via a second bus, wherein the program makes a computer to carry out: a process of receiving a login request when a login request for acquirement of a right to access to the device comes from the first electronic apparatus; a process of receiving a logout request when a logout request for abandonment of the access right acquired upon receipt of the login request comes from the first electronic apparatus; and power control by turning on power supply to the device when a login request to the device comes from the first electronic apparatus.

Additionally, the invention relates to a program that controls data transfer between a first electronic apparatus connected via a first bus and a device connected via a second bus, wherein the program makes a computer to carry out: a process of receiving a login request when a login request for acquirement of a right to access to the device comes from the first electronic apparatus; a process of receiving a logout request when a logout request for abandonment of the access right acquired upon receipt of the login request comes from the first electronic apparatus; and power control by turning off or saving power supply to the device when a logout request to the device comes from the first electronic apparatus.

### BRIEF DESCRIPTION OF THE DRAWINGS

The invention will be described with reference to the accompanying drawings, wherein like numbers refer to like elements and wherein:

FIG. 1 is a diagram to explain an outline of a SBP-2 process.

FIG. 2 is a diagram to explain data transfer of the SBP-2 using an ORB including a write command.

FIG. 3 is a diagram to explain data transfer of the SBP-2 using an ORB including a read command.

FIGS. 4 A to 4C are diagrams to explain a login ORB, a logout ORB, and the like.

FIG. 5 is an example configuration of a data transfer control system and an electronic apparatus of the embodiment.

FIG. 6 is another example configuration of the data transfer control system and the electronic apparatus of the embodiment.

FIGS. 7A to 7C are diagrams to explain the technique of the embodiment.

FIGS. 8A to 8C are diagrams to explain the technique of the embodiment.

FIG. 9 is a flowchart illustrating a process of the embodiment.

FIG. 10 is a flowchart illustrating the process of the embodiment.

FIG. 11 is a flowchart illustrating the process of the embodiment.

### DESCRIPTION OF THE EMBODIMENT

The embodiment of the invention will now be described. The embodiment hereinafter described will not unduly limit the content of the invention described in the claims. Further, not all the configurations explained in the embodiment are indispensable aspects of the invention.

1.1 EEE1394, SBP-2

1.1 SBP-2

IEEE1394 protocols (e.g. IEEE1394-1995, P1394a, and P1394b) consist of a transaction layer, a link layer, and a physical layer. Further, a protocol called Serial Bus Protocol-2 (SBP-2) has been proposed as an upper protocol that partially includes functions of the transaction layer of IEEE1394 (to define broadly, a first interface standard). This SBP-2 (SBP) has been proposed so that an SCSI command set can be used on the IEEE1394 protocol.

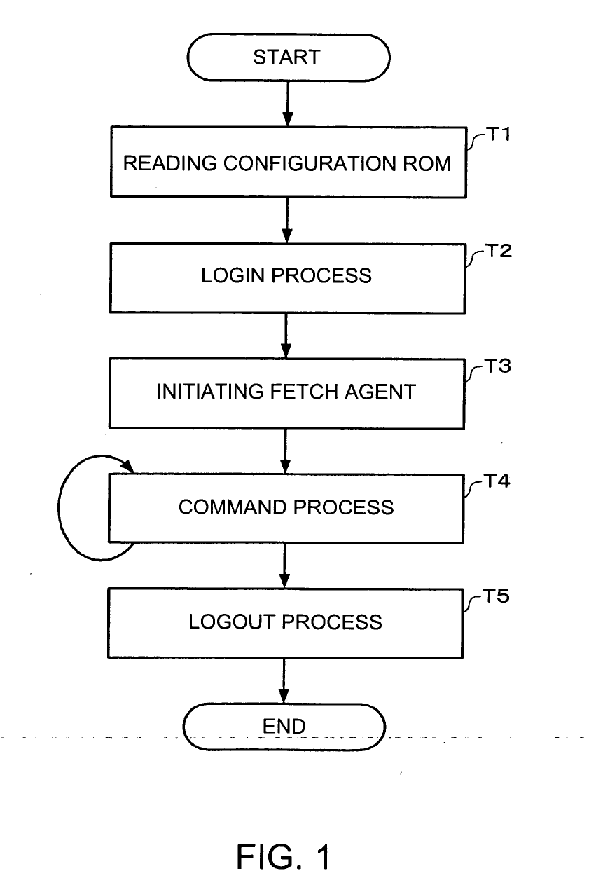

FIG. 1 is a flowchart illustrating an outline of a process of the SBP-2 (broadly, an upper first protocol of the first interface standard). With the SBP-2, a read process of a configuration ROM is first conducted in order to verify connection devices (step T1). Next, a login process is conducted (step T2) so that an initiator (an electronic apparatus or a host system such as a personal computer) acquires the right to access (the right to use a bus) to a target (a device such as HDD). More specifically, the login process is carried out using a login operation request block (ORB) created by the initiator. Then, a fetch agent is initiated (step T3). Thereafter, a command process is carried out (step T4) using a command block ORB (a command packet), and, finally, a logout process is carried out (step T5) using a logout ORB.

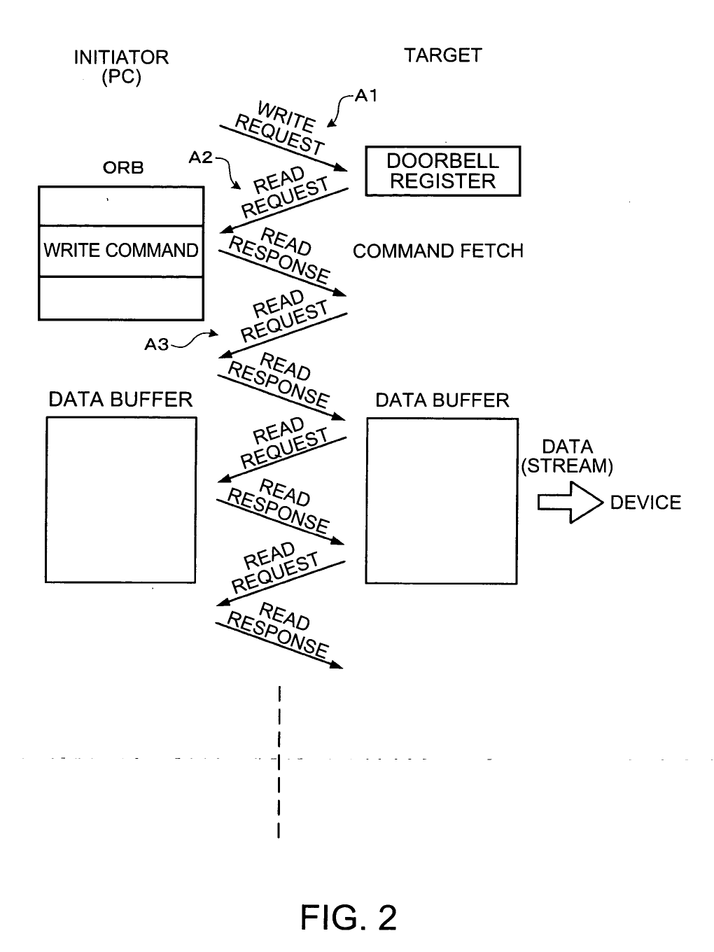

In the command process of the step T4 in FIG. 1, the initiator sends a write request packet and rings a doorbell register of the target as shown at A1 in FIG. 2. Then, as shown at A2, the target sends a read request packet, and the initiator sends back a corresponding read response packet. Consequently, the ORB created by the initiator is fetched by a data buffer of the target, which then analyzes a command included in the fetched ORB.

Then, if the command included in the ORB is a write command of SCSI, the target sends a read request packet to the initiator, which then sends a corresponding read response packet to the initiator as shown at A3. Consequently, data stored in the data buffer of the initiator is sent to the target and written into a device (a storage device such as HDD) of the target.

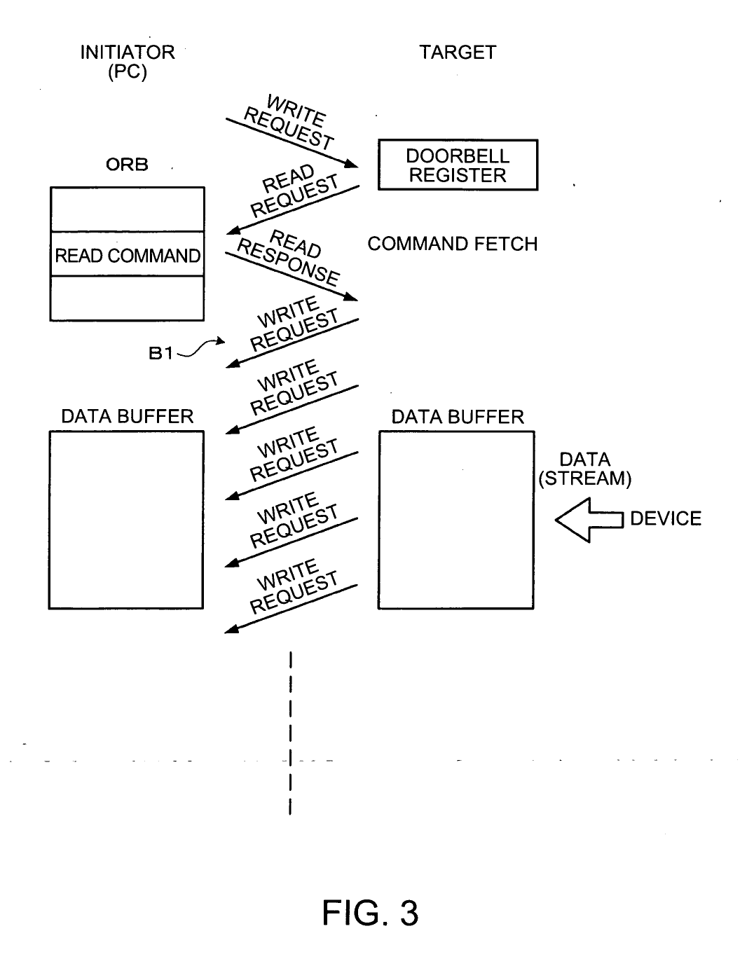

In contrast, if the command included in the ORB is a read command of SCSI, the target sends a series of write request packets to the initiator as shown at B1 of FIG. 3. Consequently, data read out from the device is transferred to the data buffer of the initiator.

According to the SBP-2, the target is able to create a request packet (issues a transaction) at its own convenience and to send/receive the data. Therefore, since there is no need for the initiator and the target to operate in synchronization with each other, data transfer efficiency can be increased.

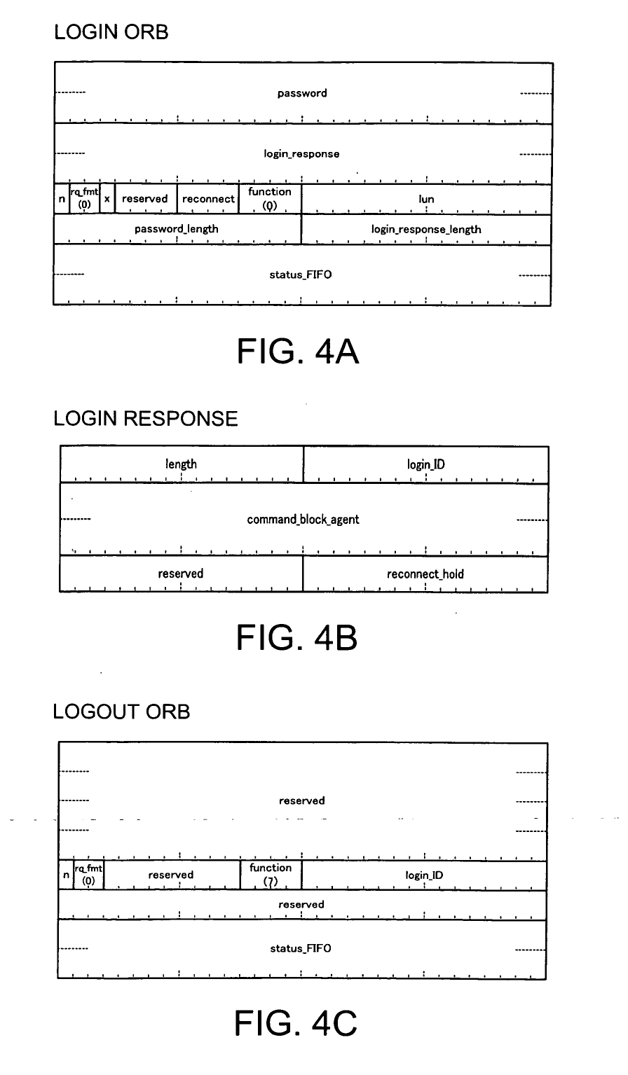

Further, the login process in the step T2 of FIG. 1 can be conducted when the initiator sends the login ORB shown in FIG. 4A to the target, which then returns the login response packet shown in FIG. 4B to the initiator. Also, the logout process of the step T5 in FIG. 1 can be conducted when the initiator sends the logout ORB shown in FIG. 4C to the target.

2. General ConFIG.uration

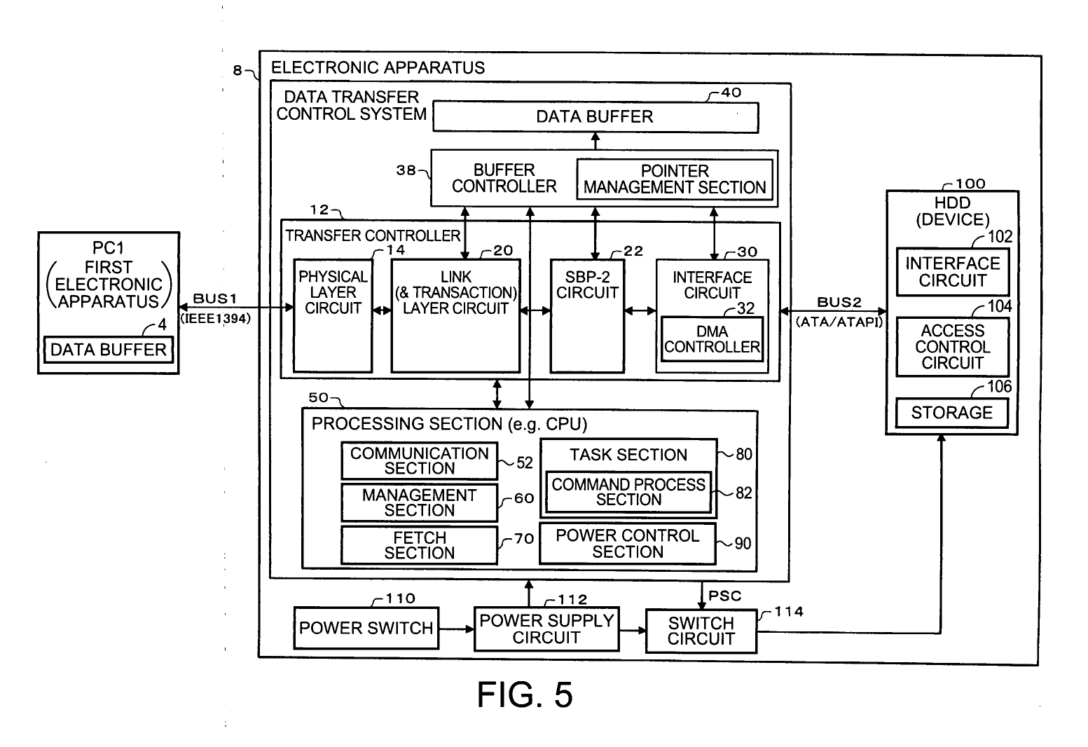

FIG. 5 shows an example configuration of the data transfer control system and the electronic apparatus including the same of the embodiment. It should be noted that, although the hard disc drive (HDD) is exemplified in the following descriptions as the device to be contained in the electronic apparatus which is the target, the invention is not limited to the HDD. For example, the device contained in the electronic apparatus may be any storage device other than the HDD, such as an optical disc drive or a magnet-optical disc drive, or it may be any device other than such storage device. Further, although a personal computer (a PC) is exemplified in the following descriptions as the first electronic apparatus connected to the electronic apparatus via a BUS1, the invention is not limited thereto. For example, the first electronic apparatus may be any electronic apparatus other than the PC, such as a portable information-processing terminal or a cellular phone. Further, the BUS1 may be any high-speed serial bus (including a multi-channel serial bus) other than the IEEE1394 bus, and part of or the entire BUS1 may be wireless.

A personal computer PC1 containing a data buffer 4 (to define broadly, the first electronic apparatus, or the first host system) and an electronic apparatus 8 are connected by the BUS1 (the first bus, or the first serial bus) which complies with IEEE1394 or the like.

Further, the electronic apparatus 8 includes a data transfer control system 10 and a device 100 (a single or plural logical units). Also, the electronic apparatus 8 further includes: a power switch 110 for turning on/off power of the electronic apparatus 8 (the data transfer control system 10), a power supply circuit 112 that supplies power when the power switch 110 is turned on, and a switch circuit 114 that turns on or off (or saves) power supply from the power supply circuit 112 to a HDD 100 based on a power control signal PSC coming from the data transfer control system 10. In addition, although FIG. 5 shows a case in which there is one HDD which is a logical unit, there may be more than one logical units. Also, the electronic apparatus 8 may contain a system CPU (not shown), a system memory (ROM or RAM), an operation section, a display section, and a signal processing device, for example.

The data transfer control system 10 includes a transfer controller 12, a buffer controller 38, a data buffer 40, and a processing section 50. Alternatively, some of these elements may be omitted. For example, the buffer controller 38 and the data buffer 40 may be omitted.

The transfer controller 12 is a controller that controls the data transfer between the PC1 (the first electronic apparatus) connected by the BUS1 and the HDD 100 (the device) connected by the BUS2.

The buffer controller 38 is a controller that controls access (write access and read access) to the data buffer 40 that temporarily stores the transfer data. The buffer controller 38 contains a pointer management section 39. This pointer management section 39 controls pointers of the data buffer 40 by a ring buffer method and carries out a process of renewing a plurality of pointers for writing and reading. Further, the buffer controller 38 can contain a register that controls the buffer controller 38, an adjustment circuit that adjusts connection of the bus to the data buffer 40, a sequencer that generates various control signals, and the like.

The data buffer 40 (a packet buffer) is a buffer (a storage) that temporarily stores the transfer data (the packets) and is composed of such hardware as an SRAM, a SDRAM, or a DRAM. Additionally, in the embodiment, the data buffer 40 can be accessed randomly. Also, the data buffer 40 may be installed outside the data transfer control system 10 instead of inside thereof.

The transfer controller 12 contains a physical layer (PHY) circuit 14, a link layer (& transaction) circuit 20, an SBP-2 circuit 22, and an interface circuit 30. The transfer controller 12 may not necessarily include all the circuit blocks shown in FIG. 5 but may exclude some of them. For example, the physical layer (PHY) circuit 14 may be excluded.

The physical layer circuit 14 is a circuit to realize a physical layer protocol by use of hardware and includes a function of inverting logical symbols used by the link layer circuit 20 into electric signals. The link layer circuit 20 is a circuit to realize part of the link layer protocol or the transaction layer protocol by use of hardware and provides various services for the packet transfers between nodes. Having these functions, the physical layer circuit 14 and the link layer circuit 20 make it possible to carry out the data transfer in compliance with IEEE1394 between the data transfer control system 10 and the PC1 via the BUS1.

The SPB-2 circuit 22 (to define broadly, a transfer executing circuit) is a circuit that carries out part of the SBP-2 protocol or of the transaction layer by use of hardware. This function of the SBP-2 circuit 22 makes it possible to divide the transfer data into a series of packets and to continuously transfer the series of divided packets.

The interface circuit 30 is a circuit that carries out an interface process between the data transfer control system 10 and the HDD 100 (to define broadly, the device). This function of the interface circuit 30 makes it possible to carry out the data transfer in compliance with an AT Attachment (ATA) and an ATA packet interface (ATAPI) between the data transfer control system 10 and the HDD 100 via the BUS2.

In addition, the physical layer circuit 14, the link layer circuit 20, the interface circuit 30, and the like enable the data transfer control system 10 to have the conversion bridge function of IEEE1394 (to define broadly, the first interface standard) and of ATA (IDE)/ATAPI (broadly, the second interface standard).

A DMA controller 32 contained in the interface circuit 30 is a circuit that carries out a direct memory access (DMA) transfer between the data transfer control system 10 and the HDD 100 via the BUS2. Further, the HDD 100 connected by the BUS2 includes an interface circuit 102 that carries out the data transfer in compliance with ATA (IDE)/ATAPI, an access control circuit 104 that controls access (write-in or read-out control) to a storage 106, and the storage 106 such as a hard disc.

The processing section 50 carries out control of the data transfer and control of the whole apparatus. The processing section 50 includes a communication section 52, a management section 60, a fetch section 70, a task section 80, and a power control section 90. Alternatively, some of these sections may be omitted. Each of these sections included in the processing section 50 can be operated by a program (firmware) that operates with a hardware circuit such as the CPU (the processor) on the CPU. This program (a process module) can be stored in an electrically erasable and programmable read only memory (EEPROM) or a storage such as ROM. Alternatively, some or all of these sections in the processing section 50 may be operated by an application specific hardware circuit (ASIC).

The communication section 52 carries out an interface process between the processing section 50 and the hardware circuits such as the physical layer circuit 14 and the link layer circuit 20.

The management section 60 (a management agent) conducts management processes such as login, reconnect, logout, and reset. For example, when a login request (a login ORB) for acquirement of the right to access to the HDD (the device) comes from the PC1 (the first electronic apparatus or the initiator), the management section 60 conducts the process of receiving this login request at first. Also, when the logout request (the logout ORB) for abandonment of the access right acquired upon receipt of the login request comes from the PC1, the management section 60 conducts the process of receiving this logout request.

When the login request is received, the data transfer (a stream transfer) between the PC1 connected via the BUS1 and the HDD 100 connected via the BUS2 becomes possible. That is, the control of the transfer controller 12 makes it possible to operate the data transfer between the PC1 and the HDD 100. In contrast, when the logout request is received, the PC1 loses the right to access to the HDD 100, and the data transfer between the PC1 and the HDD 100 stops.

The fetch section 70 (a fetch agent) carries out processes such as receiving the operation request blocks (ORBs), issuing statuses, and requesting commands to the task section 80. The fetch section 70 differs from the management section 60 which can only handle a single request but can handle linked lists of the ORBs that the fetch section 70 itself has fetched upon request from the initiator.

The task section 80 (a storage task section) processes the commands included in the ORB and the DMA transfer. The task section 80 contains a command processing section 82.

The command processing section 82 carries out various processes pertaining to the ORB that is transferred via the BUS1 (the first bus of the first interface standard such as IEEE1394). More specifically, after the login request is accepted and when the command ORB (a command packet) from the PC1 is received, the data transfer between the data transfer control system 10 and the HDD 100 connected via the BUS2 (the second bus of the second interface standard such as ATA/ATAPI) starts based on the command (the command of SCSI or SPC-2) given by the ORB. Even more specifically, the command processing section 82 issues the command included in the ORB to the HDD 100 upon receipt of the ORB from the PC1 and starts the DMA transfer (the data transfer without interference of the processing section) via the BUS2.

The power (and clock) control section 90 conducts various controls pertaining to the power (and clock) supply to the HDD 100 or the link layer circuit 20 (the transfer controller 12). For example, when the login request to the HDD 100 comes from the PC1 (when the login request is accepted), the power control section 90 conducts the power control by turning on the power supply to the HDD 100. More specifically, the power control section 90 activates the power control signal PSC that controls the power supply to the HDD 100. Then, the switch circuit 14 that has received this power control signal PSC supplies power from the power supply circuit 112 to the HDD 100. As a consequence, because there will be no power supplied from the power supply circuit 112 to the HDD 100 until the login request comes, electricity consumption can be reduced. Then, when the login request comes, the HDD 100 is able to operate properly on the power supplied from the power supply circuit 112.

In contrast, when a logout request to the HDD comes from the PC1 (when a logout request is received), the power control section 90 carries out the power control by turning off (or saving) power supply to the HDD 100. More specifically, the power control section 90 sets the power control signal PSC inactive. Then, the switch circuit 114 that has received this power control signal PSC turns off (or save) the power supply from the power supply circuit 112 to the HDD 100. As a consequence, when the PC1 loses the right to access to the HDD 100, which will then stop being used, the power supply to the HDD 100 can be turned off (or saved), and reduction of electricity consumption becomes possible.

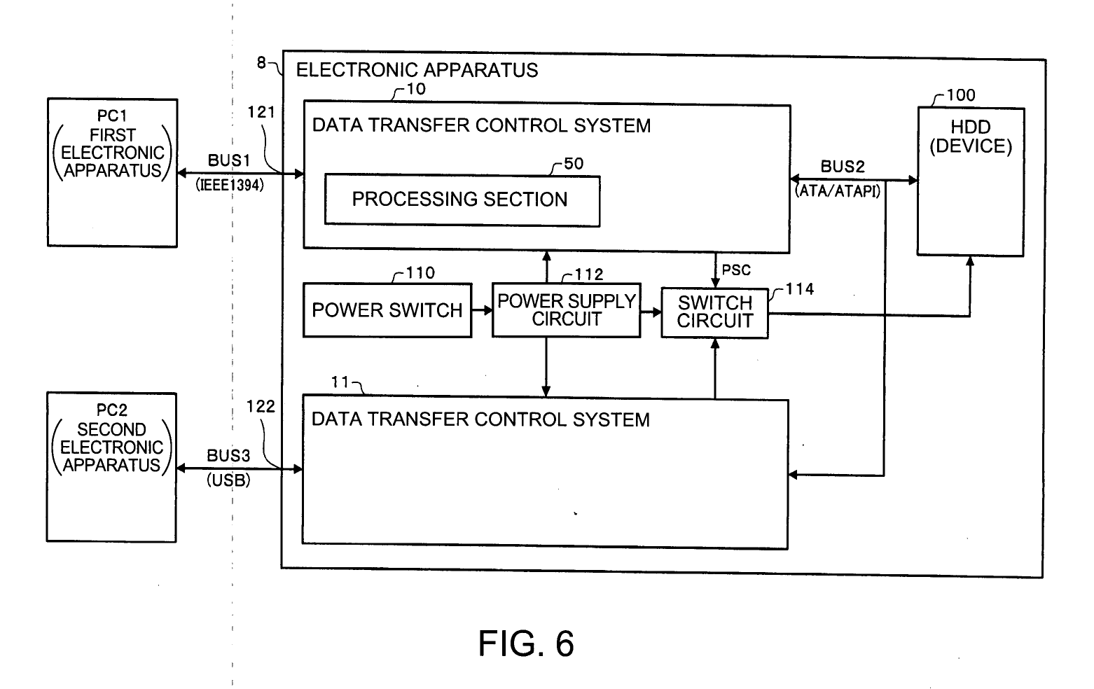

FIG. 6 is another configuration example of the data transfer control system and the electronic apparatus of the embodiment. In FIG. 6, the electronic apparatus 8 contains a port 121 for the first bus BUS1 (for IEEE1394) and a port 122 for the third bus BUS3 (for the USB). Then, the data transfer control system 10 (a first data transfer control IC) controls the data transfer (the first data transfer process) between the PC1 (the first electronic apparatus) connected via the BUS1 (the port 121) and the HDD 100 connected via the BUS2. Further, a data transfer control system 11 (a second data transfer control IC) controls the data transfer (the second data transfer process) between the PC2 (the second electronic apparatus) connected via the BUS3 (the port 122) and the HDD 100 connected via the BUS2.

According to the configuration of FIG. 6, the PC2 can write in or read in data using the HDD 100 when the PC1 is not using the HDD 100. More specifically, when the BUS1 is not in an active state (the cable is not active) and when the power supply of a VBUS (to define broadly, a power line) of the BUS3 is turned on, the first data transfer process between the PC1 and the HDD 100 is switched to the second data transfer process between the PC2 and the HDD 100. In contrast, when the PC2 is not using the HDD 100, the PC1 can write in or read in data using the HDD 100. More specifically, when the BUS1 is active and when the power supply of the VBUS of the BUS3 is turned off, the second data transfer process between the PC2 and the HDD 100 is switched to the first data transfer process between the PC1 and the HDD 100.

3. Technique Used in the Embodiment

3.1 Power Linking Operation

Conventionally, when the power switch 110 of the electronic apparatus 8 is on, the power supply to the HDD 100 also stays on. Therefore, after the power switch 110 is turned on and before the PC1 logs into the HDD 100, electricity is being consumed at the HDD 100.

However, during a period before the PC1 logs into the HDD 100, the PC1 does not have the right to access to the HDD 100, and the HDD 100 is not being in use. Thus, the electricity consumed at the HDD 100 during this period is wasted.

Hence, in the embodiment, a power linking operation that controls the power supply to the device (the HDD) is conducted depending on the login/logout status of IEEE1394 and the connected/disconnected status of the IEEE1394 cable. Further, in the case of the USB, the power linking operation that controls the power supply to the device is conducted depending on the on/off status of the VBUS and the connected/disconnected status of the USB cable.

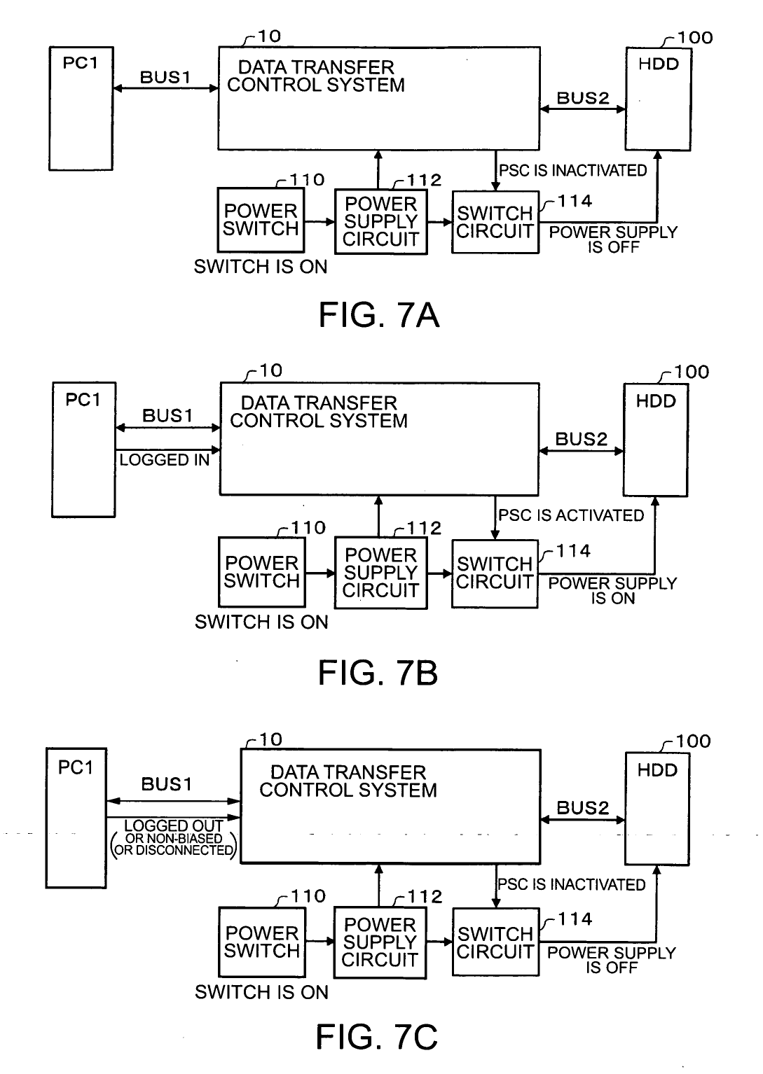

More specifically, as shown in FIG. 7A, even when the power switch 110 of the electronic apparatus 8 is turned on, the power supply to the HDD 100 stays off. In other words, the power control section 90 sets the power control signal PSC inactive, and, receiving this, the switch circuit 114 turns off the power supply from the power supply circuit 112 to the HDD 100.

Then, as shown in FIG. 7B, upon receiving the login request from the PC1, the power supply to the HDD 100 is turned on. More specifically, the power control section 90 sets the power control signal PSC active, and, receiving this, the switch circuit 114 turns on the power supply from the power supply circuit 112 to the HDD 100. When the login request is accepted, the PC1 can occupy and use the HDD 100. Therefore, by turning on the HDD 100 power on condition that the login request has come, the data transfer (the DMA transfer) between the PC1 and the HDD 100 can be conducted based on the command ORB issued by the PC1 after having received the login request. Further, in the embodiment, even when the power switch 110 is on, unless the login request comes, the power supply to the HDD 100 does not get turned on. Thus, according to the embodiment, during the period after the power switch 110 is turned on and until the login request comes in, the wasteful consumption of electricity can be avoided.

In this case, it is possible to use a technique in which the power supply to the HDD 100 is turned “on” on condition that the BUS1 is biased or connected. However, by this technique, the electricity is consumed wastefully at the HDD 100 during the period after the BUS1 is biased or disconnected until the login request comes in. In contrast, in the present embodiment, even when the BUS1 is biased or connected, unless the login request comes, the power supply to the HDD 100 does not get turned on; therefore, it is possible to realize the power control that can highly effectively reduce the electricity consumption.

Further, in the embodiment, when the logout request comes from the PC1, the power supply to the HDD 100 is turned off as shown in FIG. 7(C). More specifically, the power control section 90 sets the power control signal PSC inactive, and, receiving this, the switch circuit 114 turns off the power supply from the power supply circuit 112 to the HDD 100. When the logout request is accepted, the PC1 loses its right to occupy the HDD 100 and cannot use the HDD 100 anymore. Therefore, even after the logout, electricity will be wastefully consumed if the HDD 100 power stays on. In this respect, according to the embodiment, the power supply to the HDD 100 is turned off after the logout, and, thereby, unwanted consumption of electricity at the HDD 100 can be avoided.

Additionally, in the embodiment, even when the BUS1 is non-biased (a state in which the biased voltage is not supplied) or disconnected (a state in which the BUS1 cable is not physically connected), the power supply to the HDD 100 is set off. As a consequence, if the PC1 is suspended and the BUS1 turns non-biased, or if the IEEE1394 cable is removed and the BUS1 becomes turns, for example, it is possible to avoid the unwanted consumption of electricity.

There is a technique, for example, in which the power supply the HDD 100 is turned off on a single condition that the BUS1 has turned non-biased or disconnected. However, with this technique, the power supply to the HDD 100 gets turned off only when the PC1 is suspended and the BUS 1 turns non-biased or when the BUS1 cable is removed and disconnected; therefore, even when the PC1 logs out, the power supply to the HDD 100 does not get turned off.

On the contrary, in the embodiment, the power supply to the HDD 100 can be turned off as the PC1 logs out even when, for example, the PC1 is not suspended but is at a normal state or the BUS1 cable stays connected. Therefore, it is possible to realize the power control that highly effectively reduces the electricity consumption. Also, according to the embodiment, the power supply to the HDD 100 can be turned off by the logout process by the software. Therefore, with the software process alone, and without changing hardware specifications, it is possible to realize a highly flexible power control that does not consume as much electricity.

Now, the descriptions hereinbefore were made of the technique in which the power supply to the HDD 100 is turned on when the login request comes and is turned off when the logout request comes. However, it is not necessary to employ the part of the technique in which the power supply to the HDD 100 is turned off when the logout request comes, while employing the part in which the power supply to the HDD 100 is turned on when the login request comes. Alternatively, it is not necessary to employ the part of the technique in which the power supply to the HDD 100 is turned on when the login request comes, while employing the part in which the power supply to the HDD 100 is turned off when the logout request comes.

3.2 Switching Control of the Data Transfer Processes

In the configuration of FIG. 6, the first data transfer control process between the PC1 and the HDD 100 and the second data transfer control process between the PC1 and the HDD 100 can be conducted. In the embodiment, the switching control between the first and second data transfer control processes is conducted as in the following.

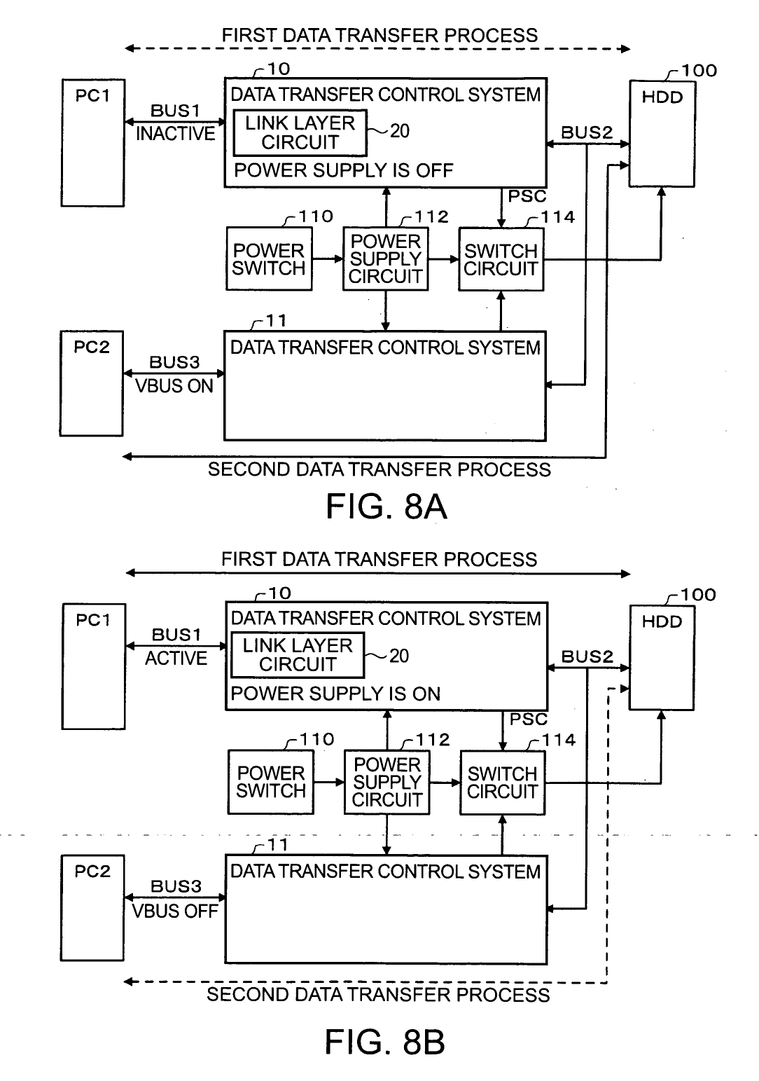

To describe specifically, as shown in FIG. 8A, when the BUS1 is not in an active state and the power supply of the VBUS of the BUS3 connected to PC2 is turned to an on state (when the voltage of the VBUS exceeds a predetermined voltage), the first data transfer control process between the PC1 and the HDD 100 is switched (shifted) to the second data transfer control process between the PC2 and the HDD 100. Note that an active state means a state in which the BUS1 cable is physically connected, the biased voltage is supplied, and it is ready to transfer the data.

Further, in the embodiment, as shown in FIG. 8A, when the first data transfer control process is switched to the second data transfer control process, the power control section 90 conducts the power control by turning off the power supply to the link layer circuit 20 (and the SBP-2 circuit 22, for example) used for the first data transfer control process. As a consequence, because the power supply to the link layer circuit 20 that is unused during the second data transfer control process is turned off, it is possible to realize the power control that can highly effectively reduce the electricity consumption.

Furthermore, in the embodiment, as shown in FIG. 8B, when the BUS1 is active and the power supply of the VBUS of the BUS3 connected to the PC2 is turned off, the second data transfer control process between the PC2 and the HDD 100 is switched to the first data transfer control process between the PC1 and the HDD 100.

By switching the data transfer control processes (data transfer paths) using the technique as described, the PC1 and the PC2 can share the HDD 100, and the users' convenience can be improved. Further, the switching control can be simplified because the switching of the data transfer control processes can be determined only by detecting whether the BUS1 is active or not or whether the VBUS is turned on or not.

Further, it is desirable that the switching between the first and the second data transfer control processes (the bus acquirement process) be conducted at power down when the power supply to the HDD 100 is turned off. More specifically, it is desirable that the switching of the data transfer processes be carried out at power down of the HDD 100 and when the PC1 is not logged into the HDD 100. It is thereby possible to prevent the data transfer processes from getting switched when the PC1 and PC2 are in the middle of making access to the HDD 100.

4. Process in Detail

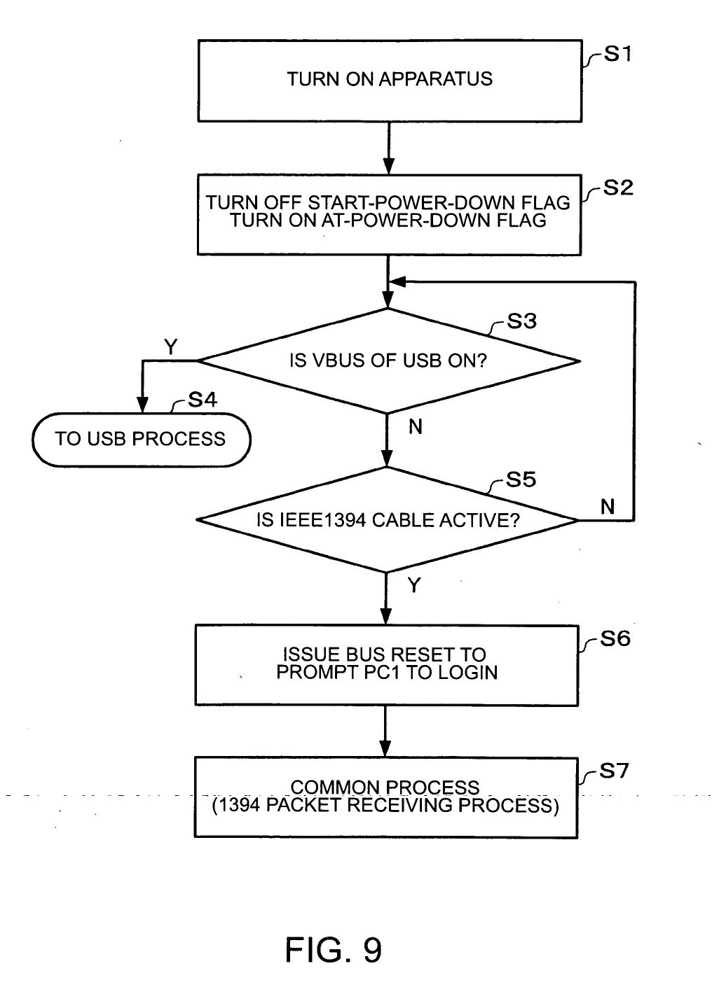

Next, an exemplified process of the technique of the embodiment will be described in detail with reference to the flowcharts of FIGS. 9 to 11.

FIG. 9 is a flowchart of the process beginning with turning on the power and ending with completion of initialization. When the power of the apparatus (the electronic apparatus or the data transfer control IC) is turned on (step S1), a start-power-down flag and an at-power-down flag, which are inner-control variables, are set off and on, respectively (step S2).

Next, it is determined whether or not the VBUS of the USB is on (the VBUS power supply is on, or the USB cable is connected) (step S3). Then, if the VBUS is on, as described with reference to FIG. 8(B), the process moves to the UBS process (the second data transfer process) (step S4). As a consequence, the control is handed to the USB. In contrast, if the VBUS is not on, it is determined whether or not the IEEE1394 cable is active (biased; the IEEE 1394 cable is connected; or the data transfer control is possible) (step S5).

If the IEEE1394 cable is not active, the process returns to the step S3. On the other hand, if the cable is active, the bus reset is issued so as to prompt the PC1 (the host system) to log in. This means completion of the initialization, and, thereby, the bus reset is issued in order to prompt the PC1 to log in. Then, the process moves to the common process (the 1394 packet receiving process) (step S7). More specifically, when the PC1 is connected via IEEE1394, and when the PC1 has started, the reading out of the configuration ROM and the login request are carried out, and then the process moves to the common process.

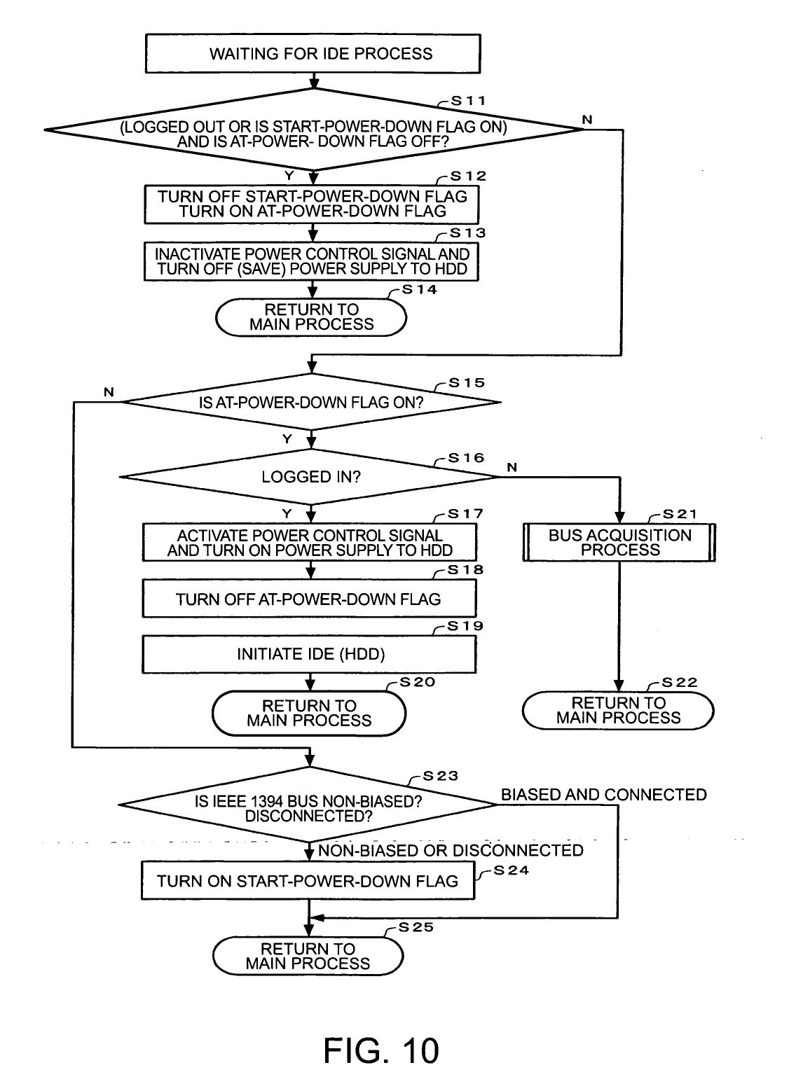

FIG. 10 is a flowchart of a process to be called when there is no process for the IDE (ATA, ATAPI) device (HDD) (or the IDE process is waiting).

First, it is determined if it is logged out or the start-power-down flag is on and, also, if the at-power-down flag is off (step S11). Then, when it is logged out and the at-power-down flag is off, or when the start-power-down flag is on and the at-power-down flag is off, the start-power-down flag is set off, and the at-power-down flag is set on (step S12). After that, as described with reference to FIG. 7(C), the IDE power control signal PSC is turned non-active, thereby turning off (saving) the power supply to the HDD (step S13). Thereafter, the process returns to a main routine process (step S14).

In contrast, if, in the step S11, it is determined that it is logged out, the start-power-down flag is off, or the at-power-down flag is on, the process then moves to the step S15. Then, it is reconfirmed whether or not the at-power-down flag is on, and, if it is on, it is then determined whether or not it is logged in (steps S15 and S16). Then, if it is logged in, as described referring to FIG. 8B, the power control signal PSC is turned active, and the power supply to the HDD is turned on (step S17). Further, the at-power-down flag is brought back to off (step S18), the IDE (the HDD) is initialized (step S19), and the process goes back to the main routine process (step S20).

In contrast, if, in the step S16, it is determined not to be in the login state, the process moves to the bus acquirement process (the process of switching the data transfer processes) (step S21). Then, it returns to the main routine process in which the bus acquirement process ends (step S22).

If, in the step S15, the at-power-down flag is determined to be not on, it is then determined whether or not the IEEE1394 bus is non-biased or disconnected or not (step S23). Then, if it is determined that the IEEE1394 bus is non-biased or disconnected, the start-power-down flag is set on, and the process returns to the main routine process (steps S24 and S25). On the contrary, if the IEEE1394 bus is determined to be biased and connected, the process simply goes back to the main routine process (step S25).

After the apparatus power is turned on, for example, the at-power-down flag is set on (the step S2 of FIG. 9). Thus, in this case, the step S11 moves to the steps S15 and S16 of FIG. 10. Then, if it is determined as being logged in in the step S16, it moves to the steps S17, S18, S19, and S20, and the power supply to the HDD is turned on while the at-power-down flag is set off. The process then returns to the main routine process.

Thereafter, if it is determined to be logged out, the process moves from the step S11 to the steps S12, S13, and S14 of FIG. 10, and the power supply to the HDD is turned off. Then, the process returns to the main routine process.

In contrast, if, in the step S23, it is determined that the IEEE1394 bus is non-biased or disconnected, the process moves to the steps S24 and S25, and the start-power-down flag is set on. The process thereby returns to the main routine process. Accordingly, in the step S11, because the start-power-down flag is on thereafter, the process moves to the steps S12, S13, and S14, and the power supply to the HDD is turned off. Then, the process returns to the main routine process.

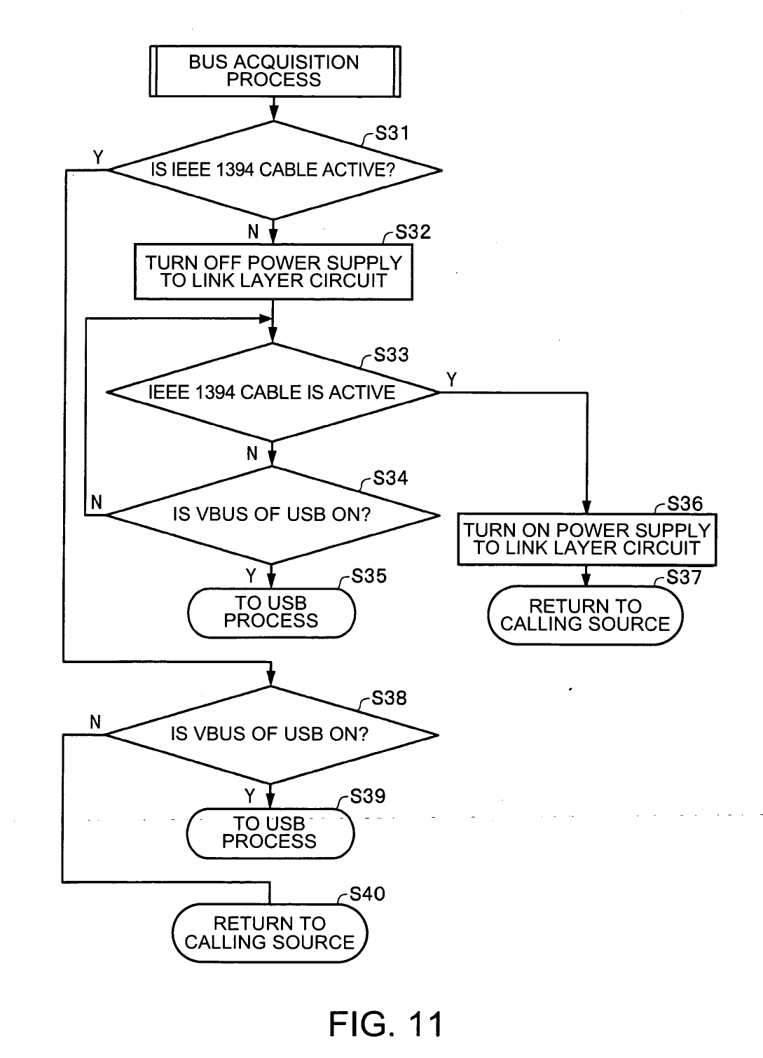

FIG. 11 is a flowchart of the bus acquirement process of the step S21 of FIG. 10. First, it is determined whether the IEEE 1394 cable is active or not (step S31). Then, if the cable is not active, the power supply to the link layer circuit (the SBP-2 circuit) is turned off (step S32) as described with reference to FIG. 8(A). Then, until the IEEE1394 cable is turned active or until the VBUS of the USB is turned on, steps S33 and S34 are repeated. Then, if the VBUS is turned on, the process moves to the USB process (the second data transfer process) (step S35) as described in FIG. 8(A). In contrast, if the IEEE1394 cable is activated, the power supply to the link layer circuit is turned on (step S36) as described in FIG. 8(B), and the process returns to a calling source (the step S21 of FIG. 10) (step S37). That is, it returns to the IEEE1394 process.

In the step. S31, if it is determined that the cable of IEEE1394 is active, it is then determined whether or not the VBUS of the USB is on (step S38). Then, if it is on, the process moves to the USB process (step S39). In contrast, if it is not on, the process returns to the calling source (the step S21 of FIG. 10) (step S40).

It is to be noted that the invention is not limited to the present embodiment, and various alternative embodiments may be possible within the gist of the invention. For example, the terms (e.g., PC1, PC2, HDD, VBUS, IEEE1394, ATA/ATAPI, and SBP-2) used in some descriptions of the specification and drawings and replaced with other terms (e.g., the first electronic apparatus, the second electronic apparatus, the device, the power line, the first interface standard, the second interface standard, the upper first protocol of the first interface standard) that are broader than or synonymous with these terms can also be replaced with the broader or synonymous terms in other descriptions in the specification and drawings.

Further, the configuration of the data transfer control system and the electronic apparatus is not limited to the configurations illustrated in FIGS. 5 and 6 and can be modified in various says. For example, some of the blocks in FIGS. 5 and 6 may be omitted, and the connections of the blocks may be altered. Furthermore, the device connected to the second bus (BUS2) is not limited to such storage device as the HDD. Moreover, the connection configurations of the physical layer circuit, the link layer circuit, and the data buffer are not limited to those shown in FIG. 5.

Also, in the embodiment, it is described that the management section, the power control section, and the like are operated with the firmware (program); however, part or all of these sections may be operated with the hardware circuits.

In addition, the invention can be applied to various electronic apparatuses such as hard disc drives, optical disc drives, magnet-optical disc drives, portable information terminals, PDAs, extension equipment, audio equipment, digital video cameras, cellular phones, printers, scanners, TVs, VTRs, telephones, display devices, projection equipment, personal computers, and electronic organizers.

Moreover, in the embodiment, it is described that the invention is applied to the data transfer based on the IEEE1394, USB, SBP-2, and ATA/ATAPI standards. However, the invention can also be applied to a data transfer based on standards having similar ideas to these standards or on standards that have been developed from these standards.

1. A data transfer control system that controls data transfer between a first electronic apparatus connected via a first bus and a device connected via a second bus, comprising:
a management section that conducts a process of receiving a login request when a login request for acquirement of a right to access to the device comes from the first electronic apparatus and that conducts a process of receiving a logout request when a logout request for abandonment of the access right acquired upon receipt of the login request comes from the first electronic apparatus; and
a power control section that conducts power control by turning on power supply to the device when the login request to the device comes from the first electronic apparatus.

2. The data transfer system according to claim 1, wherein the power control section conducts power control by turning off or saving power supply to the device when a logout request to the device comes from the first electronic apparatus.

3. The data transfer system according to claim 1, wherein the power control section conducts power control by turning off or saving power supply to the device when the first bus turns non-biased or disconnected.

4. The data transfer system according to claim 1, wherein a first data transfer process between the first electronic apparatus and the device is switched to a second data transfer process between the second electronic apparatus and the device when the first bus is not in an active state and when power supply of a power line of a third bus that is connected to a second electronic apparatus is in an on state.

5. The data transfer system according to claim 4, wherein the power control section conducts power control by turning off power supply to a link layer circuit used for the first data transfer process when the first data transfer process is switched to the second data transfer process.

6. The data transfer system according to claim 4, wherein the second data transfer process is switched to the first data transfer process when the first bus is in an active state and when power supply of the power line of the third bus is in an off state.

7. The data transfer system according to claim 6, wherein the power control section conducts power control by turning on power supply to a link layer circuit used for the first data transfer process when the second data transfer process is switched to the first data transfer process.

8. A data transfer control system that controls data transfer between a first electronic apparatus connected via a first bus and a device connected via a second bus, comprising:
a management section that conducts a process of receiving a login request when a login request for acquirement of a right to access to the device comes from the first electronic apparatus and a process of receiving a logout request when a logout request for abandonment of the access right acquired upon receipt of the login request comes from the first electronic apparatus; and
a power control section that conducts power control by turning off or saving power supply to the device when the logout request to the device comes from the first electronic apparatus.

9. An electronic apparatus comprising:
the data transfer system of claim 1; and
the device connected via the second bus.

10. The electronic apparatus according to claim 9, further comprising:
a power switch that turns on or off power of an electronic apparatus;
a power supply circuit that supplies power when the power switch is turned on; and
a switch circuit, which receives a power control signal for controlling power supply from the data transfer control system to the device, supplies power from the power supply circuit to the device when the power control signal turns active, and turns off or saves power supply from the power supply circuit to the device when the power control signal turns inactive.

11. A program that controls data transfer between a first electronic apparatus connected via a first bus and a device connected via a second bus, wherein the program makes a computer to carry out:
a process of receiving a login request when a login request for acquirement of a right to access to the device comes from the first electronic apparatus;
a process of receiving a logout request when a logout request for abandonment of the access right acquired upon receipt of the login request comes from the first electronic apparatus; and
power control by turning on power supply to the device when a login request to the device comes from the first electronic apparatus.

12. A program that controls data transfer between a first electronic apparatus connected via a first bus and a device connected via a second bus, wherein the program makes a computer to carry out:
a process of receiving a login request when a login request for acquirement of a right to access to the device comes from the first electronic apparatus;
a process of receiving a logout request when a logout request for abandonment of the access right acquired upon receipt of the login request comes from the first electronic apparatus; and
power control by turning off or saving power supply to the device when a logout request to the device comes from the first electronic apparatus.
